(19) United States
(12) Patent Application Publication
(10) Pub. No.: US 2026/0042179 A1
(43) Pub. Date: Feb. 12, 2026

(54) CASSETTE HAVING FLEXIBLE RETENTION FEATURES

(71) Applicant: ENTEGRIS, INC., Billerica, MA (US)

(72) Inventors: Mohamad Zakaria Abd Mutholib, Kulim (MY); Sin Ghun Lim, Butterworth (MY)

(21) Appl. No.: 19/295,431

(22) Filed: Aug. 8, 2025

Related U.S. Application Data
(60) Provisional application No. 63/681,647, filed on Aug. 9, 2024.

(51) Int. Cl. B23Q 7/10

(52) U.S. Cl. CPC B23Q 7/10; B23Q 2240/002

(57) ABSTRACT

A substrate container includes a container door, a container shell, and a cassette. The cassette includes slots for accommodating substrates, a handle, and vertical retention features extending above the handle and attached to the cassette. The vertical retention features are configured to contact the container shell when the container is closed around the cassette. The vertical retention features can be configured to deflect when contacting the container shell.

### FIELD

This disclosure is directed to cassettes for containing substrates, the cassettes including flexible features for vertical retention, and containers including such cassettes.

### BACKGROUND

Cassettes within substrate containers require vertical retention to avoid displacement of the container even when the container is closed. Cassettes are typically retained within a container using a separate cassette hold down and cassette springs formed on an interior of a shell of the container.

### SUMMARY

This disclosure is directed to cassettes for containing substrates, the cassettes including flexible features for vertical retention, and containers including such cassettes.

By using vertical retention provided as part of the cassette itself, the cassette hold down can be eliminated while still providing suitable vertical retention for the cassette. The elimination of the cassette hold down can reduce the number of parts in the container, reduce costs, simplify opening and closure of the cassette and improve the interactions of the container with automation.

In an embodiment, an article includes a cassette. The cassette includes a first side wall, a second side wall opposite the first side wall, a rear wall, a top wall, and a bottom wall. The top wall includes a handle and one or more vertical retention features. Each of the one or more vertical retention features is configured to extend vertically above the handle. Each of the one or more vertical retention features is configured to contact a shell of a container for the cassette when the container is closed around the cassette.

In an embodiment, at least one of the one or more vertical retention features are configured to be deflected when contacting the shell of the container for the case when the container is closed around the cassette.

In an embodiment, the one or more vertical retention features are formed integrally with the cassette.

In an embodiment, the one or more vertical retention features are attached to the cassette by one or more welds.

In an embodiment, at least one of the one or more vertical retention features includes a vertical portion, and a horizontal portion extending from the vertical portion towards one of the first side wall or the second side wall.

In an embodiment, at least one of the one or more vertical retention features is an arc extending from the top wall.

In an embodiment, at least one of the one or more vertical retention features includes a first vertical portion, a second vertical portion, and an arc extending from the first vertical portion to the second vertical portion, the arc configured to contact the shell of the container.

In an embodiment, at least one of the one or more vertical retention features includes a vertical portion, and a horizontal portion, the horizontal portion extending from a top of the vertical portion towards each of the rear wall and a front opening opposite the rear wall.

In an embodiment, an article includes a container configured to accommodate a cassette. The container includes a shell and a door. The container further includes a cassette including a first side wall, a second side wall opposite the first side wall, a rear wall, a top wall, and a bottom wall. The top wall includes a handle and one or more vertical retention features, and each of the one or more vertical retention features is configured to extend vertically above the handle. Each of the one or more vertical retention features is configured to contact the shell of a container for the cassette when the container is closed around the cassette.

In an embodiment, at least one of the one or more vertical retention features are configured to be deflected when contacting the shell of the container for the case when the container is closed around the cassette.

In an embodiment, the one or more vertical retention features are formed integrally with the cassette.

In an embodiment, the one or more vertical retention features are attached to the cassette by one or more welds.

In an embodiment, at least one of the one or more vertical retention features includes a vertical portion, and a horizontal portion extending from the vertical portion towards one of the first side wall or the second side wall.

In an embodiment, at least one of the one or more vertical retention features is an arc extending from the top wall.

In an embodiment, at least one of the one or more vertical retention features includes a first vertical portion, a second vertical portion, and an arc extending from the first vertical portion to the second vertical portion, the arc configured to contact the shell of the container.

In an embodiment at least one of the one or more vertical retention features includes a vertical portion, and a horizontal portion, the horizontal portion extending from a top of the vertical portion towards each of the rear wall and a front opening opposite the rear wall.

In an embodiment, the shell of the container includes one or more contact regions, and the one or more vertical retention features are positioned and/or configured to contact the shell of the container only at the one or more contact regions.

In an embodiment, a method of securing a cassette in a container includes placing the cassette on a door of the container. The cassette includes a first side wall, a second side wall opposite the first side wall, a rear wall, a top wall, and a bottom wall. The top wall includes a handle and one or more vertical retention features, and each of the one or more vertical retention features is configured to extend vertically above the handle. The method further includes securing a shell of the container to the door of the container such that the vertical retention features of the cassette contact the shell of the container.

In an embodiment, the vertical retention features deflect when the shell of the container is secured to the door of the container.

In an embodiment, the shell of the container includes one or more contact regions, and the one or more vertical retention features contact the shell of the container only at the one or more contact regions when the shell of the container is secured to the door of the container.

### BRIEF DESCRIPTION OF THE DRAWINGS

FIG. 1 shows a container according to an embodiment.

FIG. 2 shows a cassette according to an embodiment.

FIG. 3A shows a cassette according to an embodiment.

FIG. 3B shows a cassette according to an embodiment.

FIG. 3C shows a cassette according to an embodiment.

FIG. 3D shows a cassette according to an embodiment.

FIG. 3E shows a cassette according to an embodiment.

FIG. 4 shows a method according to an embodiment.

### DETAILED DESCRIPTION

This disclosure is directed to cassettes for containing substrates, the cassettes including flexible features for vertical retention, and containers including such cassettes.

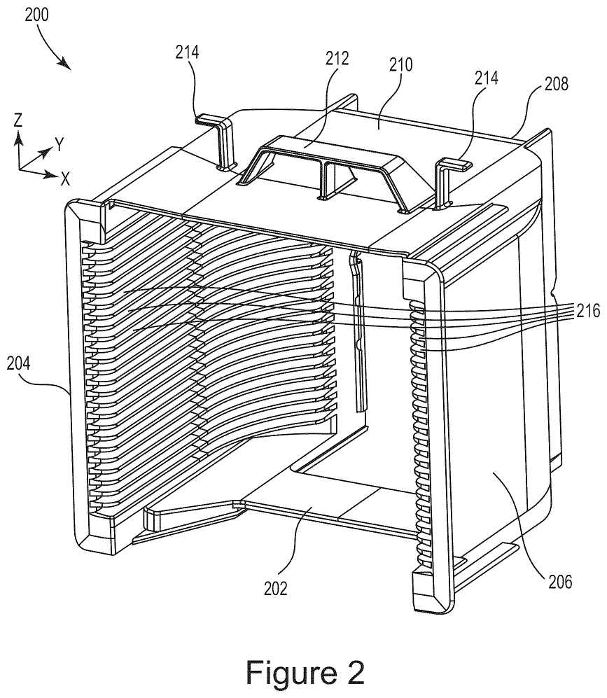

As used herein, the vertical direction is a Z-direction as shown in FIG. 2. The vertical direction can be perpendicular to a plane of a container door on which a cassette is to be placed.

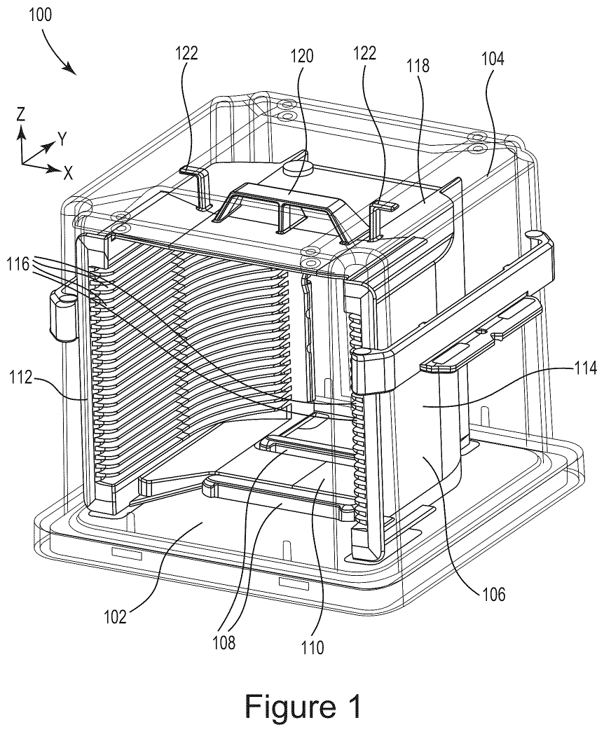

As used herein, the horizontal direction is a direction in an X-Y plane as shown in FIG. 1. The horizontal direction can be in plane with a plane of a container door on which a cassette is to be placed.

As used herein, “vertical retention” refers to structures providing force (for example, through interference, spring force, combinations thereof, and the like) opposing movement in the z-direction separating a cassette from a door, or the force provided by such structures.

FIG. 1 shows a container according to an embodiment. Container 100 includes door 102, shell 104, and cassette 106. Door 102 includes alignment features 108. Cassette 106 includes horizontal bar 110, first side wall 112, second side wall 114, substrate supports 116, top wall 118, handle 120, and vertical retention features 122.

Container 100 is a container configured to accommodate one or more substrates. A non-limiting example of container 100 is a standard mechanical interface (SMIF) pod. In container 100, door 102 and shell 104 combine to define an internal space capable of accommodating cassette 106, with cassette 106 containing the one or more substrates to be contained within the container 100. Container 100 can be a bottom-opening container where the door 102 forms a bottom of the container 100, with the shell 104 placed over the door 102 and the cassette 106 to enclose the container with substrates in an internal space of the container 100.

Door 102 is configured to enclose the shell 104 so as to define an internal space. Door 102 can be configured to fit within an opening provided on a bottom of shell 104, such that shell 104 can be placed over the door 102 and cassette 106.

Alignment features 108 can include one or more features provided on a surface of the door 102 configured to face the internal space defined by door 102 and shell 104. Alignment features 108 can be configured to interface with cassette 106 so as to align the cassette within the container 100. In an embodiment, the alignment features 108 can include one or more depressions, channels, projections, ribs, flanges, or the like. In an embodiment, alignment features 108 include a plurality of projections configured to surround a horizontal bar 110 provided on a bottom side of the cassette 106.

Shell 104 is configured to define an internal space of the container 100. The shell 104 can include a top wall and side walls, with an open end on a bottom of shell 104. The open end at the bottom of shell 104 can be configured to receive the door 102 so as to enclose the internal space. The internal space defined by shell 104 can be sized to accommodate the cassette 106 when the cassette 106 is positioned on the door 102 and the shell attached to the door.

Cassette 106 is configured to receive one or more substrates. The one or more substrates can be, for example, wafers. The one or more substrates the cassette 106 is configured to receive can be, for example, wafers having a predetermined size. Cassette 106 defines an internal space. The cassette 106 can include first and second side walls 112, 114, a top wall 118, a horizontal bar 110, and optionally rear and/or bottom walls. Cassette 106 can be formed of any suitable materials, such as polymer materials. Non-limiting examples of polymer materials usable for cassette 106 include polyolefins, polycarbonate, and the like.

Horizontal bar 110 can be provided at a bottom of the cassette 106. The horizontal bar 110 can be configured to interface with alignment features 108 such that the cassette 106 is retained in a desired alignment when the cassette 106 is placed on the door 102. The horizontal bar 110 can extend across at least a portion of the bottom of the cassette. In an embodiment, the horizontal bar 110 can extend across a width direction of the cassette 106, for example from first side wall 112 to second side wall 114. In an embodiment, the horizontal bar 110 can project vertically downwards from or be accessible from below the cassette 106. In an embodiment, vertical retention provided by the vertical retention features 122 can maintain the interfacing of horizontal bar 110 with the alignment features 108.

First side wall 112 and second side wall 114 define sides of the cassette 106. First side wall 112 and second side wall 114 are spaced apart by at least a width of the substrate to be accommodated within the cassette 106. Substrate supports 116 extend from first side wall 112 and second side wall 114, towards an interior of the internal space of cassette 106. Substrate supports 116 are positioned so as to define slots each capable of accommodating a substrate, the substrate supported within the slot by resting on opposing substrate supports 116.

Top wall 118 defines an upper surface of the internal space of cassette 106. Handle 120 extends upwards from top wall 118 on an outside of the cassette 106. Handle 120 is configured to allow engagement such that cassette 106 can be lifted off of the door 102, for example by automation, manually by a user, or the like.

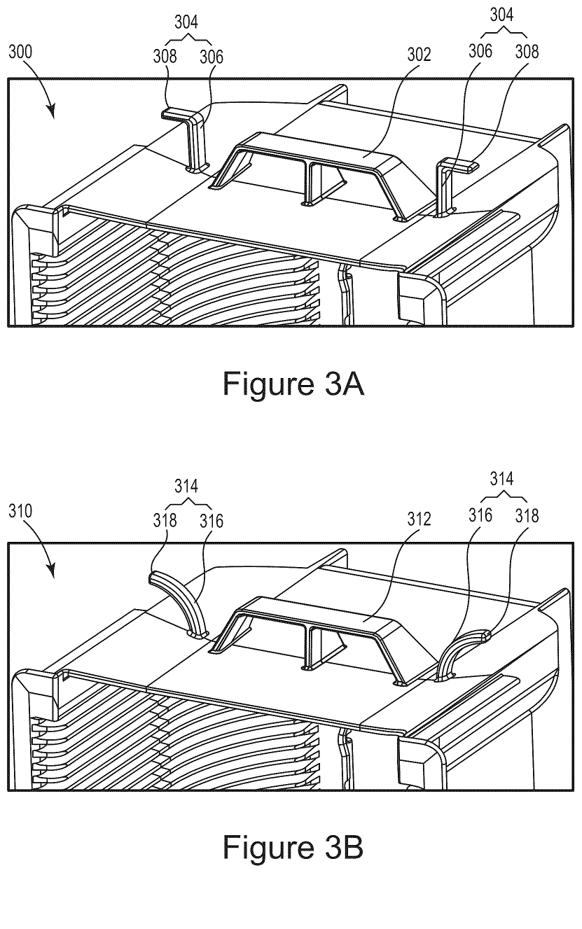

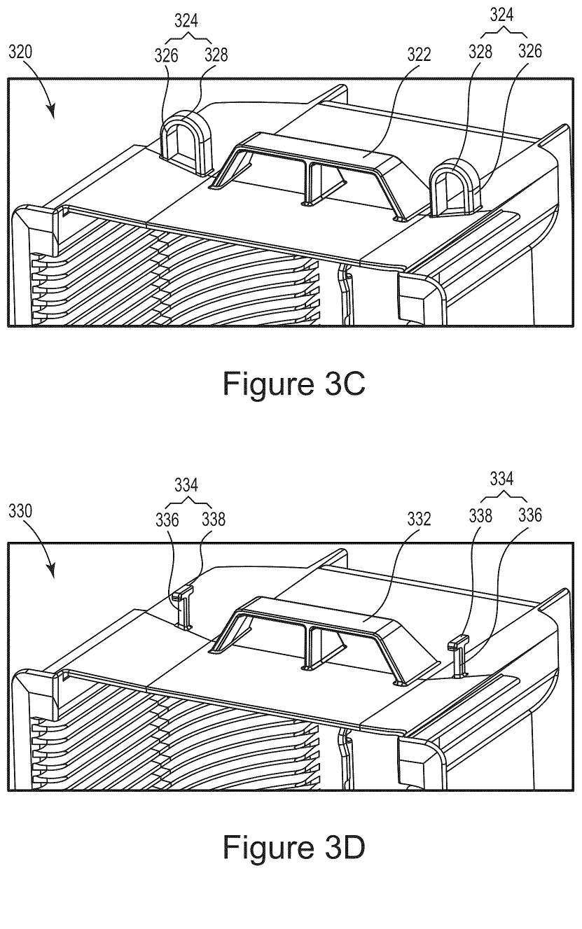

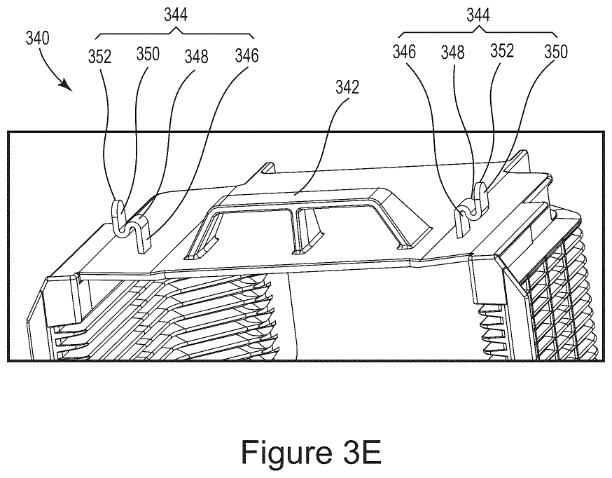

Vertical retention features 122 extend from the top wall 118. The vertical retention features 122 are configured to extend vertically above a top of the handle 120, such that when the shell 104 is attached to the door 102 with cassette 106 included within, the vertical retention features 122 contact the shell 106. The vertical retention features 122 can be positioned on the top wall 118 and/or shaped so as to contact the shell 106 only at contact regions thereof, where the vertical retention features can make contact so as to suitably deflect. The contact regions can be flat surfaces of the internal surface of shell 106, separate from angled regions, step-ins, or other features thereof that may limit contact, restrict suitable deflection, or the like. Vertical retention features 122 can be configured, for example through size, shape, material selection, and the like, to deflect when contacting the shell 104 when door 102 is affixed thereto. Non-limiting examples of suitable positions and shapes for the vertical retention features are provided in FIGS. 3A-3E and described below. Vertical retention features 122 are configured to provide vertical retention, for example by interference with the shell 106, spring force supplied through deflection of the vertical retention features, or the like.

In an embodiment, vertical retention features 122 are formed of the same material used for the body of cassette 106. In an embodiment, the vertical retention features 122 can be formed of a different material. The material selected for vertical retention features 122 can be selected based on the rigidity or compliance of the material so as to provide suitable vertical retention force by contact of the vertical retention features 122 with the shell 104. Non-limiting examples of materials usable in vertical retention features include polyolefins, polycarbonates, fluoropolymers, and the like. In an embodiment, at least some of the vertical retention features 122 are formed integrally with the body of the cassette 106. In an embodiment where the vertical retention features 122 are formed integrally with the body of cassette 106, the materials used for vertical retention features 122 can be melt-processible polymer materials. For example, the vertical retention features 122 can be features included in the mold used to form the body of cassette 106 when the vertical retention features 122 are formed of the same material. In an embodiment, the vertical retention features 122 can be formed through subsequent molding steps in a multi-step process so as to be formed integrally with the body while being formed of different materials from the body of cassette 106. In an embodiment, at least some of the vertical retention features 122 are attached to the body of the cassette 106. Examples of suitable attachments for the vertical retention features include mechanical engagements, welds, and the like. A non-limiting example of attachment of the vertical retention features 122 to the cassette 106 is ultrasonic welding. In an embodiment, each of vertical retention features 122 are attached to the cassette 106 using the same type of attachment such as all being welded, all being attacked by mechanical engagement, all being attached by fasteners, or the like.

In an embodiment, the vertical retention features 122 can be the only source of vertical retention of cassette 106 within the container 100. In an embodiment, container 100 does not include a cassette hold down or any separate element configured to provide vertical retention of cassette 106 within the container 100.

FIG. 2 shows a cassette according to an embodiment. Cassette 200 includes horizontal bar 202, first side wall 204, second side wall 206, back wall 208, top wall 210, and handle 212. Vertical retention features 214 extend from top wall 210. The first side wall 204 and second side wall 206 include substrate supports 216.

Cassette 200 is configured to be placed within a shell and a door of a container, such as the door 102 and shell 104 of container 100 as described above and shown in FIG. 1. Cassette 200 is configured to accommodate one or more substrates, such as, for example, wafers of a predetermined size. The cassette 200 defines an internal space sized to allow insertion of the substrates. The substrates can be received in slots defined within the cassette 200, for example by the substrate supports 216.

Horizontal bar 202 is provided on a bottom of the cassette 200. The horizontal bar 202 is a bar extending in a width direction of the cassette 200 from first side wall 204 to second side wall 206. Horizontal bar 202 can be configured to engage with alignment features provided on a container door, such as the alignment features 108 described above and shown in FIG. 1. The horizontal bar 202 can be positioned such that the cassette 200 is positioned on the door and engaging with the alignment features, the cassette is positioned such that a container shell can be placed over the cassette 200 to interface with said door. The horizontal bar 202 can have any suitable length, width, profile, or other such features to interface with the alignment features. In an embodiment, the horizontal bar 202 can extend across an open portion of the bottom of the cassette 200. In an embodiment, the horizontal bar 202 can project downwards from a bottom wall or other such feature at a bottom of the cassette 200.

First side wall 204 and second side wall 206 are walls defining the internal space of cassette 200. First side wall 204 and second side wall 206 can be positioned on opposing sides of the horizontal bar 202. The first side wall 204 and the second side wall 206 can each include substrate supports 216 extending therefrom. The substrate supports 216 can be positioned on first and second side walls 204, 206 opposite one another, such that the respective opposing substrate supports 216 can support opposing ends of the substrate such that the substrate is level when resting on said opposing substrate supports 216. The substrate supports 216 can each be one or more projections, such as flanges. The substrate supports 216 can extend along at least a portion of the respective first or second side wall 204, 206 that the substrate support 216 extends from.

Back wall 208 can be optionally provided across a rear of the cassette 200, extending from first side wall 204 to second side wall 206 at said rear of the cassette. In an embodiment, back wall 208 can be omitted. Back wall 208 can be positioned opposite an open side of cassette 200 through which the cassette 200 is configured to receive the substrates.

Top wall 210 is a wall defining an upper surface of the internal space of cassette 200. The top wall 210 can extend from first side wall 204 to second side wall 206, and from a front of the cassette 200, for example the open side of the cassette 200, to a rear of the cassette 200, for example back wall 208. The top wall 210 includes an inner surface facing towards the internal space of the cassette 200 and an outer surface opposite the inner surface.

A handle 212 can be provided on the outer surface of the top wall 210. Handle 212 can be configured to allow the cassette to be engaged with, manually and/or by way of automation. Handle 212 extends a maximum height H1 from the top wall 210. The handle 212 can include a horizontal portion spaced apart from the top wall 210 such that the horizontal portion can be engaged from an underside thereof (for example, to allow the cassette 200 to be lifted off or lowered onto a door of a container). The spacing of the horizontal portion apart from top wall 210 can be achieved through vertical and/or diagonal portions of the handle 212 connecting to the top wall 210.

Vertical retention features 214 are features of the cassette 200 configured to be in contact with a container shell so as to provide vertical retention of the cassette 200 within the container. In an embodiment, vertical retention features 214 can be connected to one or both of the top wall 210 and handle 212. The vertical retention features 214 can be attached to the cassette 200 by any suitable connection, for example, mechanical engagement, one or more fasteners, being formed integrally, welding, or the like. In an embodiment, the vertical retention features 214 are ultrasonically welded to the cassette 200. In an embodiment, the vertical retention features 214 are formed integrally with the cassette 200, for example during a single molding process for the cassette 200 or through a multi-stage molding process including the molding of the vertical retention features 214. The vertical retention features 214 can be formed of any suitable material such as, for example, polyolefins, polycarbonates, fluoropolymers, and the like. The vertical retention features 214 can be sized, shaped, and/or use materials such that at least a portion of the vertical retention features 214 are deflected by the interference with the container. Non-limiting examples of the locations and shapes of the vertical retention features 214 are described below and shown in FIGS. 3A-3E. Vertical retention features 214 extend to a height H2 above the top wall 210, with the height H2 being greater than the height H1. The vertical retention features 214 are configured to contact the shell of the container without the shell contacting the handle 212. Vertical retention features 214 can be positioned on top wall 210 and/or handle 212 and shaped so as to contact the shell at contact regions thereof, where the vertical retention features 214 can make contact so as to suitably deflect. The contact regions can be flat surfaces of the internal surface of a shell of the container storing cassette 200, separate from angled regions, step-ins, or other features thereof that may limit contact, restrict suitable deflection, or the like. The contact of vertical retention features 214 with the shell can provide force pressing the cassette 200 against a container door, limiting the movement of the cassette 200 when the container experiences acceleration or deceleration. The vertical retention provided by vertical retention features 214 can prevent the horizontal bar 202 from escaping alignment features provided on the door of the container. The vertical retention features 214 can further deflect if the cassette 200 moves relative to the shell of the container, such that spring force on the vertical retention features increases to retain the cassette 200.

FIG. 3A shows a cassette according to an embodiment. Cassette 300 includes handle 302 and vertical retention features 304. Vertical retention features 304 include vertical portion 306 and horizontal portion 308. Vertical portion 306 extends in a direction having a major component in a vertical direction. In an embodiment, vertical portion extends in a completely vertical direction. In an embodiment, vertical portion 306 extends diagonally, with a major component of the direction of extension being vertical. Vertical portion 306 can extend from the cassette 300 from a position selected such that the horizontal portion 308 contacts a container shell (not shown) at a contact region thereof, where the vertical retention features can make contact so as to suitably deflect. The contact regions can be flat surfaces of the internal surface of shell, separate from angled regions, step-ins, or other features thereof that may limit contact, restrict suitable deflection, or the like. The horizontal portion 308 extends in a direction having a major component in a horizontal direction. In an embodiment, the horizontal portion 308 can extend in a completely horizontal direction. In an embodiment, the horizontal portion 308 extends diagonally, with a major component being in a horizontal direction. In the embodiment shown in FIG. 3A, the horizontal portion 308 extends outwards, away from handle 302 and towards first and second side walls of the cassette 300. At least a portion of the horizontal portion 308 is configured to contact the container shell. When the vertical retention features 304 contact the shell, at least a portion of one or both of the vertical portion 306 and the second portion 308 can deflect as a result of interference with the shell.

FIG. 3B shows a cassette according to an embodiment. Cassette 310 includes handle 312 and vertical retention features 314. Vertical retention features 314 include a continuous arc 316 extending to a tip 318. Vertical retention features 314 extend in a continuous arc 316 over at least a portion thereof. The continuous arc 316 can follow a curve, such as a semicircle, a parabolic curve, or any other suitable curve over the length thereof. A portion of the continuous arc 316 can be positioned vertically higher than the highest point of handle 312. Tip 318 is positioned vertically higher than a highest point of handle 312. The vertical retention features 314 are configured to contact the container shell at one or both of tip 318 and a distal region of the continuous arc 316 opposite where vertical retention features 314 meet the cassette 310. The vertical retention features 314 can be deflected along the continuous arc 316 when tip 318 or a distal portion of the continuous arc 316 contact the container shell. The radius of the continuous arc 316 and the position of the vertical retention features 314 on cassette 310 can be selected such that the tip 318 and/or the distal portion of the continuous arc 316 contact the container shell at contact regions, separate from angled regions, step-ins, or other features thereof that may limit contact, restrict suitable deflection, or the like.

FIG. 3C shows a cassette according to an embodiment. Cassette 320 includes handle 322 and vertical retention features 324. Vertical retention features 324 include vertical portions 326 and curved connector 328. Vertical portions 326 extend straight from the cassette 320 such that a major component of the vertical portions 326 is in a vertical direction. In an embodiment, vertical portions 326 extend in an entirely vertical direction. In an embodiment, vertical portions 326 extend in a diagonal direction where the vertical component is a major component of the direction of extension. Two vertical portions 326 can be included in each of the vertical retention features 324. Curved connector 328 can extend from one vertical portion to another, with a continuous curve over the length of curved connector 328. Curved connector 328 can follow any suitable curve extending between the vertical portions 326, such as a semicircle, a parabolic curve, or the like. Curved connector 328 and the two vertical portions 326 can be formed integrally with one another as a single piece vertical retention feature 324. In an embodiment, vertical portions 326 and curved connector 328 can be joined by, for example, a weld such as an ultrasonic weld. The curved connector 328 can include a contact surface at an uppermost portion of the curved connector 328, for example where a line tangent to the curved connector 328 extends in a horizontal direction. At least the contact surface is provided above a maximum height of the handle 322. The contact surface of the curved connector 328 can be configured to contact the container shell when the cassette 320 is placed on a container door and a container shell is placed over the cassette 320 and joined to the container door. The curved connector 328 and/or the vertical portions 326 of the vertical retention features 324 can deflect when contacting the container shell, for example when the door and the container shell are joined, and/or during acceleration or deceleration of the container. The vertical retention features 324 can be configured such that contact surfaces of the curved connector 328 contact the container shell at contact regions thereof, for example by the positioning of vertical portions 326 or the shape of vertical portions 326 and/or curved connector 328.

FIG. 3D shows a cassette according to an embodiment. Cassette 330 includes handle 332 and vertical retention features 334. Vertical retention features 334 include vertical portion 336 and horizontal portion 338. Vertical portion 336 extends in a direction having at least a major component in the vertical direction. In an embodiment, vertical portion 336 extends entirely in the vertical direction. In an embodiment, the vertical portion 336 extends diagonally, with a major component in the vertical direction. The horizontal portion 338 of a vertical retention feature 334 is provided at an end of the respective vertical portion 336. The horizontal portion 338 can extend in a direction having a major component in the horizontal direction. In an embodiment, the horizontal portion 338 extends from the vertical portion 336 in opposing directions, such that the vertical portion 336 meets the horizontal portion 338 along a length of the horizontal portion 338. At least part of the horizontal portions 338 are configured to contact the container shell when the cassette 330 is placed on a container door and a container shell is placed over the cassette 330 and attached to the container door. The horizontal portions 338 can be positioned above a height of the handle 332. In the embodiment shown in FIG. 3D, the horizontal portions extend in a horizontal direction parallel to a direction from the front of the cassette 330 to a back of the cassette 330. The vertical portions 336 and horizontal portions 338 are configured such that the horizontal portions 338 contact the container shell at contact regions thereof.

FIG. 3E shows a cassette according to an embodiment. Cassette 340 includes handle 342 and vertical retention features 344. Vertical retention features 344 include a first segment 346, a spring 348, and a second segment 350 extending to a tip 352. First segment 346 extends from cassette 340 to the spring 348. First segment 346 can be straight or curved. First segment 346 can extend in a direction having a vertical component. The spring 348 is disposed along the vertical retention feature 344, between the first segment 346 and second segment 350. The spring 348 can be any suitable shape configured to allow deflection at or along at least a portion of spring 348. Non-limiting examples of spring 348 can be a leaf spring, an S-shaped curve, or the like. The spring 348 can be a shape or feature formed integrally into the vertical retention feature 344. The second segment 350 can extend from an end of spring 348 opposite where first segment 346 meets the spring 348. The second segment 350 can be curved or straight. The second segment can extend in a direction having a vertical component, such that at least a portion of the second segment 350 extends vertically above the spring 348. The second segment 350 can extend to a tip 352. The tip 352 is configured to contact a container shell when cassette 340 is positioned on a container door and the container shell is placed over the cassette 340 and attached to the door. When tip 352 is in contact with the container shell, vertical retention feature 344 can be deflected, for example at spring 348. The vertical retention features 344 can be configured such that the tips 352 contact the container shell at contact regions thereof.

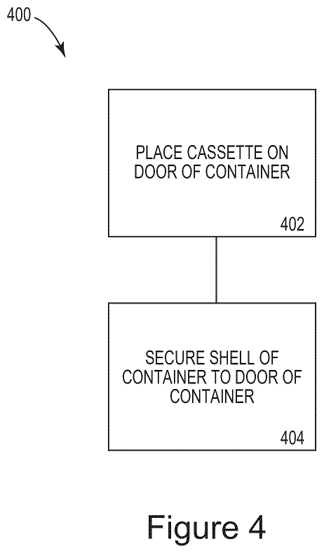

FIG. 4 shows a method according to an embodiment. Method 400 includes placing a cassette on a door of a container 402 and securing a shell of the container to the door of the container 404.

The cassette can be placed on the door of the container at 402. The cassette can be any suitable cassette including vertical retention features as described herein. The door can be a door of the substrate container. The cassette can be placed such that the cassette interfaces with alignment features provided on the door of the container, for example a horizontal bar included in the cassette fitting between a plurality of guide projections provided on the door.

A shell of the container is secured to the door at 404. The shell can be secured through any suitable mechanical connection, such as operation of a latch included in the door 404. The shell can be provided over the cassette and the door when securing the shell of the container to the door at 404. When the shell of the container is secured to the door, the vertical retention features can contact the shell of the container. In an embodiment, the vertical retention features of the cassette are configured to contact the shell of the container at predetermined contact regions where the vertical retention projections can make contact so as to suitably deflect. The contact regions can be flat surfaces of the internal surface of the shell, separate from angled regions, step-ins, or other features thereof that may limit contact, restrict suitable deflection, or the like. In an embodiment, when the shell is secured to the door at 404, the vertical retention features can be deflected by contact with the shell. In an embodiment, the shell can be secured to the door at 404 directly following placement of the cassette on the door at 402. In an embodiment, the shell can be secured to the door at 404 without a cassette hold down being placed on the cassette.

### Aspects

It is understood that any of aspects 1-8 can be combined with any of aspects 9-17 or 18-20. It is understood that any of aspects 9-17 can be combined with any of aspects 18-20.

Aspect 1. An article comprising a cassette, the cassette including:
a first side wall, a second side wall opposite the first side wall, a rear wall, and a top wall, wherein
the top wall includes a handle and one or more vertical retention features, and each of the one or more vertical retention features is configured to extend vertically above the handle, and is configured to contact a shell of a container for the cassette when the container is closed around the cassette.

Aspect 2. The article according to aspect 1, wherein at least one of the one or more vertical retention features are configured to be deflected when contacting the shell of the container for the case when the container is closed around the cassette.

Aspect 3. The article according to any of aspects 1-2, wherein the one or more vertical retention features are formed integrally with the cassette.

Aspect 4. The article according to any of aspects 1-3, wherein the one or more vertical retention features are attached to the cassette by one or more welds.

Aspect 5. The article according to any of aspects 1-4, wherein at least one of the one or more vertical retention features includes a vertical portion, and a horizontal portion extending from the vertical portion towards one of the first side wall or the second side wall.

Aspect 6. The article according to any of aspects 1-5, wherein at least one of the one or more vertical retention features is an arc extending from the top wall.

Aspect 7. The article according to any of aspects 1-6, wherein at least one of the one or more vertical retention features includes a first vertical portion, a second vertical portion, and an arc extending from the first vertical portion to the second vertical portion, the arc configured to contact the shell of the container.

Aspect 8. The article according to any of aspects 1-7, wherein at least one of the one or more vertical retention features includes a vertical portion, and a horizontal portion, the horizontal portion extending from a top of the vertical portion towards each of the rear wall and a front opening opposite the rear wall.

Aspect 9. An article, comprising:
a container configured to accommodate a cassette, the container including a shell and a door; and
a cassette including:
a first side wall, a second side wall opposite the first side wall, a rear wall, and a top wall, wherein
the top wall includes a handle and one or more vertical retention features, and each of the one or more vertical retention features is configured to extend vertically above the handle, and is configured to contact the shell of a container for the cassette when the container is closed around the cassette.

Aspect 10. The article according to aspect 9, wherein at least one of the one or more vertical retention features are configured to be deflected when contacting the shell of the container for the case when the container is closed around the cassette.

Aspect 11. The article according to any of aspects 9-10, wherein the one or more vertical retention features are formed integrally with the cassette.

Aspect 12. The article according to any of aspects 9-11, wherein the one or more vertical retention features are attached to the cassette by one or more welds.

Aspect 13. The article according to any of aspects 9-12, wherein at least one of the one or more vertical retention features includes a vertical portion, and a horizontal portion extending from the vertical portion towards one of the first side wall or the second side wall.

Aspect 14. The article according to any of aspects 9-13, wherein at least one of the one or more vertical retention features is an arc extending from the top wall.

Aspect 15. The article according to any of aspects 9-14, wherein at least one of the one or more vertical retention features includes a first vertical portion, a second vertical portion, and an arc extending from the first vertical portion to the second vertical portion, the arc configured to contact the shell of the container.

Aspect 16. The article according to any of aspects 9-15, wherein at least one of the one or more vertical retention features includes a vertical portion, and a horizontal portion, the horizontal portion extending from a top of the vertical portion towards each of the rear wall and a front opening opposite the rear wall.

Aspect 17. The article according to any of aspects 9-16, wherein the shell of the container includes one or more contact regions, and the one or more vertical retention features are positioned and/or configured to contact the shell of the container only at the one or more contact regions.

Aspect 18. A method of securing a cassette in a container, comprising:
placing the cassette on a door of the container, the cassette including:
a first side wall, a second side wall opposite the first side wall, a rear wall, a top wall, and a bottom wall, wherein
the top wall includes a handle and one or more vertical retention features, and each of the one or more vertical retention features is configured to extend vertically above the handle; and
securing a shell of the container to the door of the container such that the vertical retention features of the cassette contact the shell of the container.

Aspect 19. The method according to aspect 18, wherein the vertical retention features deflect when the shell of the container is secured to the door of the container.

Aspect 20. The method according to any of aspects 18-19, wherein the shell of the container includes one or more contact regions, and the one or more vertical retention features contact the shell of the container only at the one or more contact regions when the shell of the container is secured to the door of the container.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An article comprising a cassette, the cassette including:
a first side wall, a second side wall opposite the first side wall and a top wall, and a bottom wall, wherein
the top wall includes a handle and one or more vertical retention features, and
each of the one or more vertical retention features is configured to extend vertically above the handle, and is configured to contact a shell of a container for the cassette when the container is closed around the cassette.

2. The article of claim 1, wherein at least one of the one or more vertical retention features are configured to be deflected when contacting the shell of the container for the case when the container is closed around the cassette.

3. The article of claim 1, wherein the one or more vertical retention features are formed integrally with the cassette.

4. The article of claim 1, wherein the one or more vertical retention features are attached to the cassette by one or more welds.

5. The article of claim 1, wherein at least one of the one or more vertical retention features includes a vertical portion, and a horizontal portion extending from the vertical portion towards one of the first side wall or the second side wall.

6. The article of claim 1, wherein at least one of the one or more vertical retention features is an arc extending from the top wall.

7. The article of claim 1, wherein at least one of the one or more vertical retention features includes a first vertical portion, a second vertical portion, and an arc extending from the first vertical portion to the second vertical portion, the arc configured to contact the shell of the container.

8. The article of claim 1, wherein at least one of the one or more vertical retention features includes a vertical portion, and a horizontal portion, the horizontal portion extending from a top of the vertical portion towards each of the rear wall and a front opening opposite the rear wall.

9. An article, comprising:
a container configured to accommodate a cassette, the container including a shell and a door; and
a cassette including:
a first side wall, a second side wall opposite the first side wall, a rear wall, a top wall, and a bottom wall, wherein
the top wall includes a handle and one or more vertical retention features, and
each of the one or more vertical retention features is configured to extend vertically above the handle, and is configured to contact the shell of a container for the cassette when the container is closed around the cassette.

10. The article of claim 9, wherein at least one of the one or more vertical retention features are configured to be deflected when contacting the shell of the container for the case when the container is closed around the cassette.

11. The article of claim 9, wherein the one or more vertical retention features are formed integrally with the cassette.

12. The article of claim 9, wherein the one or more vertical retention features are attached to the cassette by one or more welds.

13. The article of claim 9, wherein at least one of the one or more vertical retention features includes a vertical portion, and a horizontal portion extending from the vertical portion towards one of the first side wall or the second side wall.

14. The article of claim 9, wherein at least one of the one or more vertical retention features is an arc extending from the top wall.

15. The article of claim 9, wherein at least one of the one or more vertical retention features includes a first vertical portion, a second vertical portion, and an arc extending from the first vertical portion to the second vertical portion, the arc configured to contact the shell of the container.

16. The article of claim 9, wherein at least one of the one or more vertical retention features includes a vertical portion, and a horizontal portion, the horizontal portion extending from a top of the vertical portion towards each of the rear wall and a front opening opposite the rear wall.

17. The article of claim 9, wherein the shell of the container includes one or more contact regions, and the one or more vertical retention features are positioned and/or configured to contact the shell of the container only at the one or more contact regions.

18. A method of securing a cassette in a container, comprising:
placing the cassette on a door of the container, the cassette including:
a first side wall, a second side wall opposite the first side wall, a rear wall, a top wall, and a bottom wall, wherein
the top wall includes a handle and one or more vertical retention features, and
each of the one or more vertical retention features is configured to extend vertically above the handle; and
securing a shell of the container to the door of the container such that the vertical retention features of the cassette contact the shell of the container.

19. The method of claim 18, wherein the vertical retention features deflect when the shell of the container is secured to the door of the container.

20. The method of claim 18, wherein the shell of the container includes one or more contact regions, and the one or more vertical retention features contact the shell of the container only at the one or more contact regions when the shell of the container is secured to the door of the container.
